(19) United States
(12) Patent Application Publication
(10) Pub. No.: US 2021/0043911 A1
(43) Pub. Date: Feb. 11, 2021

(54) CONTINUOUS CURRENT COLLECTORS IN BATTERY CONFIGURATIONS

(71) Applicant: Apple Inc., Cupertino, CA (US)

(72) Inventor: Yuriy Y. Londarenko, Scotts Valley, CA (US)

(73) Assignee: Apple Inc., Cupertino, CA (US)

(21) Appl. No.: 16/916,311

(22) Filed: Jun. 30, 2020

Related U.S. Application Data
(60) Provisional application No. 62/883,771, filed on Aug. 7, 2019.

(51) Int. Cl. H01M 2/26; H01M 4/70; H01M 4/66; H01M 2/16; H01M 10/0525

(52) U.S. Cl. CPC H01M 2/266; H01M 4/70; H01M 10/0525; H01M 2/1673; H01M 4/66

(57) ABSTRACT

Battery cells according to embodiments of the present technology may include an electrode stack including a first cell segment, a second cell segment, and a third cell segment each having an anode, a cathode, and a separator positioned between the anode and the cathode. Layering of the anode and the cathode of the second cell segment may be reversed from layering of the anode and the cathode of the first cell segment and the third cell segment. The battery cells may include a cathode current collector including a conductive material extending continuously in a U-shaped pattern to extend across and in contact with the cathode of each section of the electrode stack. The battery cells may also include an anode current collector comprising a conductive material extending continuously in a U-shaped pattern to extend across and in contact with the anode of each section of the electrode stack.

### CROSS-REFERENCES TO RELATED APPLICATIONS

The present application claims the benefit of priority to U.S. Provisional Application No. 62/883,771, filed Aug. 7, 2019, the contents of which are hereby incorporated by reference in their entirety for all purposes.

### TECHNICAL FIELD

The present technology relates to batteries. More specifically, the present technology relates to battery component configurations.

### BACKGROUND

Batteries are used in many devices. As increased energy density is sought in reduced form factors, device configurations and coupling may cause challenges.

### SUMMARY

Battery cells according to embodiments of the present technology may include an electrode stack including a first cell segment having an anode, a cathode, and a separator positioned between the anode and the cathode. The electrode stack may also include a second cell segment overlying the first cell segment and having an anode, a cathode, and a separator positioned between the cathode and the anode. The electrode stack may also include a third cell segment overlying the second cell segment and having an anode, a cathode, and a separator positioned between the anode and the cathode. Layering of the anode and the cathode of the second cell segment may be reversed from layering of the anode and the cathode of the first cell segment and the third cell segment. The battery cells may include a cathode current collector including a conductive material extending continuously in a U-shaped pattern to extend across and in contact with the cathode of each of the first cell segment, the second cell segment, and the third cell segment of the electrode stack. The battery cells may also include an anode current collector comprising a conductive material extending continuously in a U-shaped pattern to extend across and in contact with the anode of each of the first cell segment, the second cell segment, and the third cell segment of the electrode stack.

In some embodiments, the cathode current collector may extend through the electrode stack along a lateral axis orthogonal to a lateral axis along which the anode current collector extends through the electrode stack. The cathode current collector may extend through the electrode stack in a lateral axis similar to a lateral axis along which the anode current collector extends through the electrode stack. The cathode current collector and the anode current collector may be offset vertically from one another between layers of the electrode stack. The cathode current collector and the anode current collector may be laterally offset from one another and extend less than or about halfway across a lateral surface of a corresponding electrode material. The battery cell may include a solid-state battery or a liquid electrolyte battery. The separator may encompass edges of the anode and the cathode along electrode edges further encompassed by arcuate sections of the cathode current collector or the anode current collector.

The separator may extend continuously between each of the first cell segment of the electrode stack, the second cell segment of the electrode stack, and the third cell segment of the electrode stack. The separator may extend in alternating orthogonal directions between each of the first cell segment of the electrode stack, the second cell segment of the electrode stack, and the third cell segment of the electrode stack. The alternating orthogonal directions may correspond with an overhang portion of each of the cathode current collector and the anode current collector. An exposed cathode edge and an exposed anode edge may be passivated or inert. The anode and the cathode of each of the first cell segment of the electrode stack, the second cell segment of the electrode stack, and the third cell segment of the electrode stack may be laterally offset in a direction of overhang of a corresponding current collector. A laterally offset portion of each of the anodes and each of the cathodes may be ablated, passivated, or coated with an insulating material.

Some embodiments of the present technology may also encompass batteries. The batteries may include a first electrode stack including an anode, a separator, and a cathode. The batteries may include a cathode current collector extending across the cathode of the first electrode stack on a surface of the cathode of the first electrode stack opposite a surface of the cathode of the first electrode stack in contact with the separator of the first electrode stack. The batteries may include a second electrode stack including an anode, a separator, and a cathode, and characterized by a reversed layer orientation from the first electrode stack. The cathode of the second electrode stack may be in contact with a surface of the cathode current collector opposite the surface of the cathode current collector in contact with the cathode of the first electrode stack. The batteries may include an anode current collector extending across a surface of each of the anode of the first electrode stack and a surface of the anode of the second electrode stack. The anode current collector may be characterized by substantially planar ends extending substantially parallel to one another and in contact with a respective anode. The substantially planar ends may be connected by an arcuate portion of the anode current collector extending along a thickness of the first electrode stack and the second electrode stack.

In some embodiments, the anode current collector may be characterized by a first surface and a second surface opposite the first surface. The first surface of the anode current collector may be in contact with the anode of the first electrode stack, and the first surface of the anode current collector may be in contact with the anode of the second electrode stack. The batteries may include a third electrode stack including an anode, a separator, and a cathode, and characterized by a similar layer orientation as the first electrode stack. The anode of the third electrode stack may be in contact with the second surface of the anode current collector opposite the first surface of the anode current collector in contact with the anode of the second electrode stack.

The cathode current collector may be further characterized by an arcuate portion extending along a thickness of the second electrode stack and the third electrode stack. The arcuate portion of the anode current collector may be passivated along at least one of the first surface of the anode current collector and the second surface of the anode current collector. The battery cell may be or include a solid-state battery or a liquid electrolyte battery. The separator of the first electrode stack may be the separator of the second electrode stack. The separator may encompass an edge of the cathode of the first electrode stack and an edge of the cathode of the second electrode stack along an edge of the first electrode stack and the second electrode stack encompassed by the arcuate portion of the anode current collector. The anode and the cathode of each of the first electrode stack and the second electrode stack may be laterally offset in a direction of overhang of a corresponding current collector. A portion of the anode of the first electrode stack and a portion of the cathode of the first electrode stack may be ablated, passivated, or coated with an insulating material.

Such technology may provide numerous benefits over conventional technology. For example, the present batteries may be characterized by increased energy density by reducing components within the battery. Additionally, the batteries may facilitate electrode connections within the battery enclosure due to the continuous current collector designs. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic cross-sectional view of a battery cell according to some embodiments of the present technology.

FIG. 2 shows a schematic perspective view of a battery cell according to some embodiments of the present technology.

FIG. 3 shows a schematic top plan view of a battery cell according to some embodiments of the present technology.

FIG. 4A shows a schematic cross-sectional view of battery cell materials according to some embodiments of the present technology.

FIG. 4B shows a schematic cross-sectional view of battery cell materials according to some embodiments of the present technology.

FIG. 5A shows a schematic top plan view of a battery cell according to some embodiments of the present technology.

FIG. 5B shows a schematic cross-sectional view of battery cell materials according to some embodiments of the present technology.

FIG. 6 shows a schematic cross-sectional view of battery cell materials according to some embodiments of the present technology.

FIG. 7 shows a schematic cross-sectional view of battery cell materials according to some embodiments of the present technology.

FIG. 8A shows a schematic cross-sectional view of battery cell materials according to some embodiments of the present technology.

FIG. 8B shows a schematic plan view of an exemplary separator according to some embodiments of the present technology.

Several of the figures are included as schematics. It is to be understood that the figures are for illustrative purposes, and are not to be considered of scale or proportion unless specifically stated to be of scale or proportion. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Batteries, battery cells, and more generally energy storage devices, are used in a host of different systems. In many devices, the battery cells may be designed with a balance of characteristics in mind. For example, including larger batteries may provide increased usage between charges, however, the larger batteries may require larger housing, or increased space within the device. As device designs and configurations change, especially in efforts to reduce device sizes, the available space for additional battery components may be constrained. These constraints may include restrictions in available volume as well as the geometry of such a volume.

Stacked battery cell configurations having multiple cells for conventional liquid-electrolyte cells and solid-state cells often include adhesive layers to construct the stacks. Additionally, the conventional structures may include complex interconnect structures to connect the cells. These additional layers, in a given form factor, reduce energy density of the battery produced by reducing the volume available for electrode active materials. Conventional devices that have or include these structures often accept the capacity losses due to additional components incorporated within the device. The present technology may overcome these issues, however, by providing a configuration by which one or more continuous current collector structures may be used, which may reduce additional layers and interconnect requirements. After illustrating an exemplary cell that may be used in embodiments of the present technology, the present disclosure will describe battery designs having a current collector structure for use in a variety of devices in which battery cells may be used.

Although the remaining portions of the description will reference lithium-ion batteries, it will be readily understood by the skilled artisan that the technology is not so limited. The present techniques may be employed with any number of battery or energy storage devices, including other rechargeable and primary battery types, as well as secondary batteries, or electrochemical capacitors. Moreover, the present technology may be applicable to batteries and energy storage devices used in any number of technologies that may include, without limitation, phones and mobile devices, watches, glasses, bracelets, anklets, and other wearable technology including fitness devices, handheld electronic devices, laptops and other computers, motor vehicles and other transportation equipment, as well as other devices that may benefit from the use of the variously described battery technology.

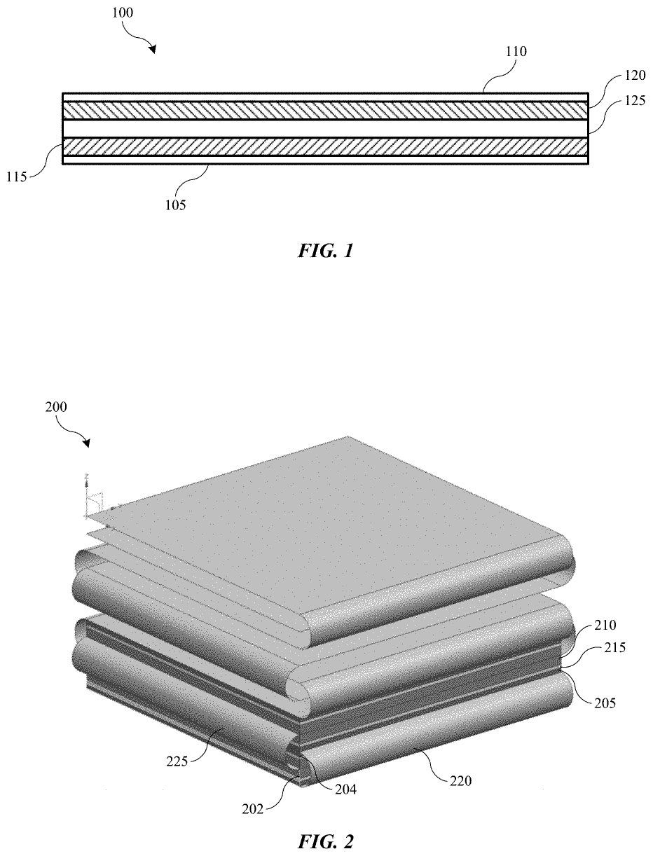

FIG. 1 depicts a schematic cross-sectional view of an energy storage device or battery cell 100 according to embodiments of the present technology. Battery cell 100 may be or include a battery cell, and may be one of a number of cells coupled together to form a battery structure. As would be readily understood, the layers are not shown at any particular scale, and are intended merely to show the possible layers of cell material of one or more cells that may be incorporated into an energy storage device. In some embodiments, as shown in FIG. 1, battery cell 100 includes a first current collector 105 and a second current collector 110. In embodiments one or both of the current collectors may include a metal or a non-metal material, such as a polymer or composite that may include a conductive material. The first current collector 105 and second current collector 110 may be different materials in embodiments. For example, in some embodiments the first current collector 105 may be a material selected based on the potential of an anode active material 115, and may be or include copper, stainless steel, or any other suitable metal, as well as a non-metal material including a polymer. The second current collector 110 may be a material selected based on the potential of a cathode active material 120, and may be or include aluminum, stainless steel, or other suitable metals, as well as a non-metal material including a polymer. In other words, the materials for the first and second current collectors can be selected based on electrochemical compatibility with the anode and cathode active materials used, and may be any material known to be compatible.

In some instances the metals or non-metals used in the first and second current collectors may be the same or different. The materials selected for the anode and cathode active materials may be any suitable battery materials operable in rechargeable as well as primary battery designs. For example, the anode active material 115 may be silicon, graphite, carbon, a tin alloy, lithium metal, a lithium-containing material, such as lithium titanium oxide (LTO), or other suitable materials that can form an anode in a battery cell. Additionally, for example, the cathode active material 120 may be a lithium-containing material. In some embodiments, the lithium-containing material may be a lithium metal oxide, such as lithium cobalt oxide, lithium manganese oxide, lithium nickel manganese cobalt oxide, lithium nickel cobalt aluminum oxide, or lithium titanate, while in other embodiments the lithium-containing material can be a lithium iron phosphate, or other suitable materials that can form a cathode in a battery cell.

The first and second current collectors as well as the active materials may have any suitable thickness. A separator 125 may be disposed between the electrodes, and may be a polymer film or a material that may allow lithium ions to pass through the structure while not otherwise conducting electricity. Active materials 115 and 120 may additionally include an amount of electrolyte in a completed cell configuration, which may be absorbed within the separator 125 as well. The electrolyte may be a liquid including one or more salt compounds that have been dissolved in one or more solvents. The salt compounds may include lithium-containing salt compounds in embodiments, and may include one or more lithium salts including, for example, lithium compounds incorporating one or more halogen elements such as fluorine or chlorine, as well as other non-metal elements such as phosphorus, and semimetal elements including boron, for example.

In some embodiments, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an exemplary combination. Any other solvent may be included that may enable dissolving the lithium-containing salt or salts as well as other electrolyte component, for example, or may provide useful ionic conductivities, such as greater than or about 5-10 mS/cm.

Although illustrated as single layers of electrode material, battery cell 100 may be any number of layers. Although the cell may be composed of one layer each of anode and cathode material as sheets, the layers may also be formed into any form such that any number of layers may be included in battery cell 100. For embodiments which include multiple layers, tab portions of each anode current collector may be coupled together, as may be tab portions of each cathode current collector, although one or more of the current collectors may be a continuous current collector material as will be described below. Once the cell has been formed, a pouch, housing, or enclosure may be formed about the cell to contain electrolyte and other materials within the cell structure. Terminals may extend from the enclosure to allow electrical coupling of the cell for use in devices, including an anode and cathode terminal. The coupling may be directly connected with a load that may utilize the power, and in some embodiments the battery cell may be coupled with a control module that may monitor and control charging and discharging of the battery cell. When multiple cells are stacked together, electrode terminals at anode potential may be coupled together, as may be electrode terminals at cathode potential. These coupled terminals may then be connected with the terminals on the enclosure as noted above.

The structure of battery cell 100 may also illustrate the structure of a solid-state battery cell, which may include anode and cathode materials as well as current collectors as noted previously. A difference between the solid-state design and liquid-electrolyte design previously explained is that in addition to not including electrolyte, separator 125 may be characterized by different materials, although the materials may be characterized by similar properties, such as the ability to pass ions through the material while limiting the passage of electrons. In solid-state configurations, the anode and cathode materials may be any of the materials noted above, as well as additional materials operable as electrode active materials within a solid-state cell. For example, anode materials may include graphene or carbon materials, lithium metal, titanium-containing materials, lithium alloys, as well as other anode-compatible materials. Cathode materials may include lithium-containing oxides or phosphates, as well as other cathode-compatible materials. The inter-electrode material, which may also be noted as 125, may include an electron-blocking material, such as a separator, as well as or alternatively, a solid electrolyte material having ion mobility. Glass materials and ceramics may be used, as well as polymeric materials that may include ion-conducting additives, such as lithium salts. In any instance where the word separator is used, it is to be understood as encompassing both separators and solid electrolytes, which may or may not incorporate separator materials. FIG. 1 is included as an exemplary cell that may be incorporated in batteries according to the present technology. It is to be understood, however, that any number of battery and battery cell designs and materials that may include charging and discharging capabilities similarly may be encompassed by or incorporated with the present technology.

FIG. 2 shows a schematic perspective view of a battery cell 200 according to some embodiments of the present technology. Battery cell 200 may include any of the materials or configurations of the cell materials illustrated in FIG. 1, and may include a solid-state cell configuration or a liquid-electrolyte configuration in some embodiments. FIG. 2 illustrates a stacked cell configuration including more than one electrode cell set, such as would include more than one current collector set, for example. Unlike conventional technologies that may stack multiple, separate current collectors within the stack and then electrically and/or physically couple the materials, the present technology utilizes a continuous current collector for one or both of the anode or cathode.

The perspective view in FIG. 2 includes exemplary components as well as one possible configuration including two continuous electrodes. It is to be understood that the figure illustrates one possible embodiment encompassed by the present technology, which may include a number of configurations and components. Although as noted that FIG. 2 may illustrate either a liquid-electrolyte battery cell configuration or a solid-state battery cell configuration, the figure will be described from the perspective of a solid-state cell, although it is not to be considered limiting.

In solid-state battery cells, a variety of manufacturing operations may be performed, which may include a number of variations. For example, material layers may be free-formed in some embodiments, as well as cast and dried in a variety of ways on unspooled current collectors. The present technology may include free-standing or cast and diced components, which may be stacked to produce a battery having any number of battery cells. As the component cells are stacked, the individual cells may be interleaved with one or more continuous current collector components as illustrated. The current collectors may be extended back and forth in one direction over the stacked cells, while rising vertically with each layer. When two continuous current collectors are used as illustrated, the components may each be extended back and forth, but in a direction orthogonal to one another as shown. Additional variations are similarly encompassed as will be described further below.

For example, as illustrated, the figure may show a first cell structure or segment 202, and a second cell structure or segment 204. Each segment may include an anode 205, a cathode 210, and a separator 215, which may be or include any of the previously noted materials. Extending across exterior surfaces of each cell may be the current collectors. A first current collector may be an anode current collector 220, and may be made of any of the anode current collector materials previously noted. The anode current collector 220 may extend in a first direction along and in contact with the anode 205 of each cell section. Similarly, a second current collector may be a cathode current collector 225, and may be made of any of the cathode current collector materials previously noted. The cathode current collector 225 may extend in a second direction along and in contact with the cathode 210 of each cell section. The cells may be stacked to any height, such as to include any number of electrode stack sections, and the current collectors may continue to be woven through the structure as illustrated. Although additional cell structures are not illustrated in the figure, it is to be understood that cell materials will continue to be incorporated in each section. Additionally, although the top-most layer and bottom-most layer are both shown to be anode material, in some embodiments the top and bottom materials may be opposite electrode materials from one another. This may facilitate electrical coupling of the current collectors with a battery enclosure or housing, and which may include terminals as previously noted. In some embodiments, the top and bottom layers may be the same materials, such as when an enclosure in which the battery cell may be disposed may be maintained at the potential of one of the electrodes. In these situations, the top and bottom layer may both be the same material.

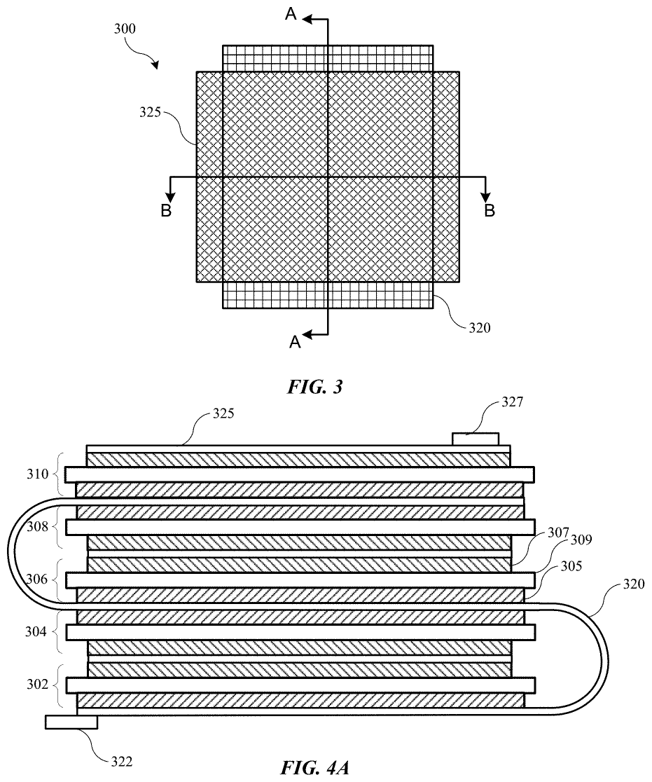

FIG. 3 shows a schematic top plan view of battery cell 300 according to some embodiments of the present technology, and may show portions of battery cell 200 described above, and may include any of the components and characteristics described elsewhere in this disclosure. As shown from above, cathode current collector 325 may be visible extending across battery cell 300 in a first direction. Anode current collector 320 may be visible extending beyond exterior dimensions of the cell material, such as arcuate sections of the current collector extending vertically along a thickness of the cell material while transitioning to an adjacent cell segment of the structure. In this illustrated configuration, a top or final layer of the battery cell may include a cathode material, while a bottom or first layer of the battery cell may include an anode material. The battery cell dimensions may be at least partially defined by the exterior sections of the current collector materials, which may extend beyond the lateral dimensions of the electrode stack. The woven current collector materials may be alternated through the electrode stack, which may include any number of stack segments, to produce a battery cell structure of any thickness.

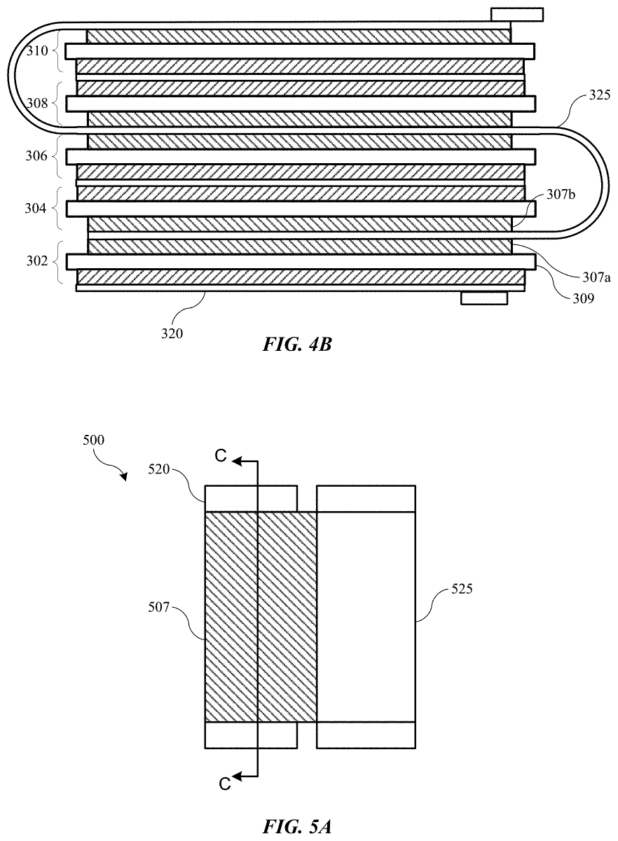

FIG. 4A shows a schematic cross-sectional view of battery cell 300 along line A-A of FIG. 3 according to some embodiments of the present technology. As illustrated, five separate cell segments corresponding to complete battery cell segments may be stacked and interleaved with current collectors according to the present technology to produce a battery cell, which may be coupled within an enclosure to form a battery useable in electronic devices. As illustrated, first cell segment 302, second cell segment 304, third cell segment 306, fourth cell segment 308, and fifth cell segment 310 may be stacked overlying one another with interleaved current collectors. Each cell segment may include an anode 305, a cathode 307, and a separator 309, with the separator positioned between the anode and the cathode of the cell segment. As previously noted, separator 309 may be a solid electrolyte layer separating the anode and the cathode electrode materials, and the solid electrolyte layer may include materials described above, including compound materials such as an electronic separator and an ion-permeable material. The cell layers may be inverted or characterized by reversed layering from each adjacent cell segment. This may allow a single current collector segment to contact and be electronically coupled with two separate cells as illustrated.

A cathode current collector 325 may be extended across and in contact with each cathode layer 307, or between each set of paired layers of cathode materials for cell segments at interior locations through the battery cell. Additionally, an anode current collector 320 may be extended across and in contact with each anode layer 305, or between each set of paired layers of anode materials for cell segments at interior locations through the battery cell. Either or both current collectors may be continuously extended across the corresponding electrode material. For coupling with battery terminals at a housing, one or more current collector tabs may be used. For example, if discreet layers of current collector material are used, then each layer may include a tab extending from the current collector. The group of tabs may be electrically coupled in various ways, and then electrically coupled with a terminal of the housing.

When continuous extensions of current collector material are used, such as illustrated, a single connection position may be used at a distal location on the current collectors. For example, the top exposed layer of battery cell 300 includes cathode current collector 325, and cathode current collector tab 327 may be coupled with, or extend from, the cathode current collector at this location. Similarly, the bottom exposed layer of battery cell 300 may include anode current collector 320, and anode current collector tab 322 may be coupled with, or extend from, the anode current collector at this location. Although listed as top and bottom, it is to be understood that the orientation may be rotated or reversed while maintaining the relationship of the components of the cell structure. Although not illustrated, these tabs may be coupled with an enclosure terminal in any number of ways, including any different type of enclosure or terminal.

Because the current collector may be a continuous conductive structure, a tab may be extended from any location along the current collector for coupling with the enclosure or terminal structure.

The current collectors may be characterized by a particular configuration through the electrode stack, depending on the number of cells in the structure. For example, in a three cell segment electrode stack, such as with cell segments 302, 304, and 306, anode current collector 320 and/or cathode current collector 325 may be characterized by a U-shaped pattern extending in contact with each of the three corresponding electrode materials. As additional segments extend the electrode stack vertically, the current collectors may be continued in an S-shaped pattern as the current collector extends back along the same lateral axis or direction across the next cell in the electrode stack. In this way, a single current collector may extend through the battery cell structure limiting interconnects for coupling multiple current collectors.

FIG. 4B shows a schematic cross-sectional view of battery cell 300 along line B-B according to some embodiments of the present technology, and may illustrate a rotated cross-section from FIG. 4A. FIG. 4B may be a cross-section illustrating the woven structure of a cathode current collector 325 through the battery cell. As illustrated, a single cathode current collector 325 may extend across and in contact with each cathode 307 of the electrode stack. For example, cathode current collector 325 may be characterized by an S-shaped pattern with this number of cell segments, and the current collector may contact the cathode 307 of each of cell segments 302, 304, 306, 308, and 310. Of course, with additional cell segments, either of the current collectors may continue the S-progression for any number of layers.

The structuring of reversed or inverted layering of electrode stack cell segments may further facilitate use of woven current collectors as illustrated. For example, cathode 307a of first cell segment 302 may be characterized by a first surface in contact with separator 309 of first cell segment 302, and a second surface opposite the first surface that is in contact with a first surface of cathode current collector 325. Cathode 307b of second cell segment 304 may be seated on a second surface of cathode current collector 325 opposite the first. By this arrangement, the anode sections of each of the first cell segment 302 and the second cell segment 304 may be positioned on vertical ends of this stacking. Accordingly, a U-shaped anode current collector may then be extended about the cells to contact each of the anode materials.

The anode current collector and/or cathode current collector may extend in a planar fashion across each segment of the electrode stack. For example, as illustrated in FIG. 4A, anode current collector 320, as extending along first cell segment 302 and second cell segment 304, may be characterized by two planar ends in contact with the anode active materials. Depending on the topography of the active materials, the two ends of the current collector may extend substantially parallel to one another, accounting for topographical issues, manufacturing tolerances, and other tolerances that may not produce perfect planarity or parallelism between the ends. The planar ends may be connected by an arcuate portion as illustrated, which may extend in a plane orthogonal to the plane along which the current collector ends extend, such as along a thickness of the two electrode stack cell segments. Of course, as the current collector is extended across additional layers, the planar regions may not be ends of the current collector through internal cell segments of the electrode stack, although the regions may be of similar planarity and parallelism as described for the end portions. Due to the curvature approximate a midpoint of the anode current collector, a first surface of the anode current collector may be in contact with each of the anode of the first cell segment and the anode of the second cell segment.

As the electrode stack extends to a third cell segment and a fourth cell segment, the current collector may extend back in the opposite direction along the same lateral axis across the vertically extending electrode stack. The third cell segment may be positioned on a second surface of the anode current collector opposite the first surface. The second surface may then wrap about the thickness of the third cell segment and the fourth cell segment as illustrated to contact the anode of the fourth cell segment with the second surface of the anode current collector. This pattern may then be repeated as the electrode stack is further extended vertically by adding additional cell segments. This structure may be further facilitated by the reverse layering of adjacent cell segments, positioning the anode of the second cell segment and the anode of the third cell segment on opposite surfaces of the anode current collector. The third cell segment may be characterized by the same cell layer orientation as the first cell segment, while the second cell segment may be reversed between the anode and cathode layers as illustrated.

As illustrated in FIG. 4B, the cathode current collector may follow a similar formation with a continuous current collector including planar sections across the stacked electrode cell segments, and arcuate portions connecting the planar regions. The anode and cathode current collector arcuate portions may extend across different cell segments as illustrated as well due to the woven pattern. For example, while anode current collector 320 may extend vertically about the first cell segment and the second cell segment, the cathode current collector 325 may extend vertically about the second cell segment and the third cell segment, which may be based on the cell layer orientation.

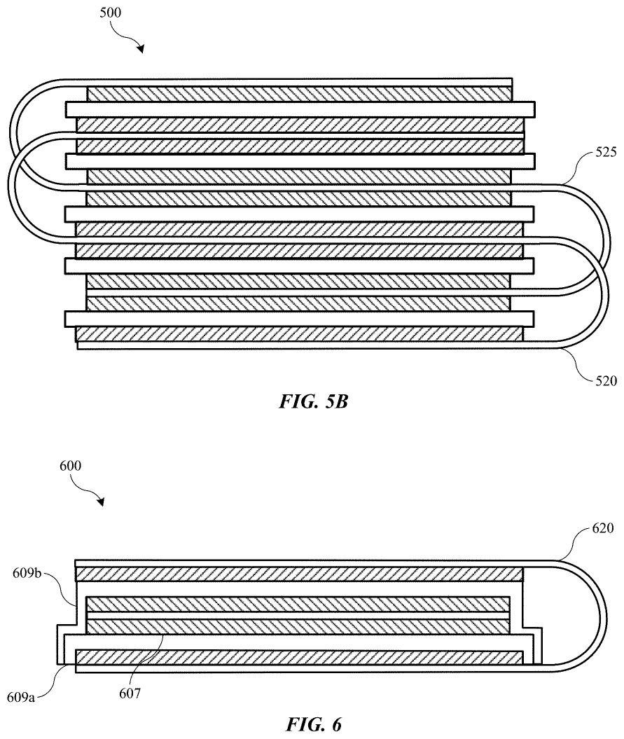

FIGS. 2-4 illustrate an embodiment of the present technology encompassing a configuration where the continuous cathode current collector extends in a back-and-forth direction along a lateral axis or direction that is orthogonal to a lateral axis or direction along which the anode current collector extends in a back-and-forth direction. Additional configurations and variations are also encompassed in some embodiments of the present technology. For example, FIG. 5A shows a schematic top plan view of a battery cell 500 according to some embodiments of the present technology. Battery cell 500 may include any of the components and characteristics described elsewhere in this disclosure, and may illustrate a configuration where the cathode current collector extends through the electrode stack along a lateral axis similar to a lateral axis along which the anode current collector extends through the electrode stack. However, arcuate portions of the current collectors may be vertically offset from one another similar to the offset illustrated previously. Additionally, as illustrated, the current collectors may be laterally offset from one another as illustrated. Accordingly, the current collectors may extend only partially across a lateral surface of the electrode active materials as illustrated, and may extend less than or about halfway across a lateral surface of a corresponding electrode material.

For example, battery cell 500 may include an anode current collector 520, and a cathode current collector 525. Although illustrated as a top layer being a cathode, similar to all other described illustrations, the reverse orientation may also be produced. Because the current collector may extend only partially across the surface of the cathode active material 507, at least a portion of the electrode material may be exposed. In some embodiments an additional material, such as separator material or passivation as described below may be extended across the additional portion of the layer to limit exposed material within the structure.

FIG. 5B shows a schematic cross-sectional view of battery cell 500 along line C-C according to some embodiments of the present technology, although FIG. 5B may illustrate only a portion of a vertical distribution of cell segments, which may include any number of additional cells, or fewer cells in embodiments. As illustrated, because the current collectors are laterally offset from one another, anode current collector 520 and cathode current collector 525 may not intersect as they extend through the electrode stack cell segments. Continuous current collectors according to embodiments of the present technology may be characterized by improved current distribution as current may not be metered at current collector tabs like many conventional configurations. When the continuous current collectors are reduced in lateral dimension, the resistance may increase over full lateral sections. In some embodiments, a thickness of the current collector may be used to offset this effect, such as by increasing a thickness of the current collector, for example.

Depending on cell type and configuration, a number of additional aspects of the present technology may be included. The described structures may be characterized by additional aspects that may provide limited electrical paths for shorting between anode and cathode materials, such as along edge regions of the structures previously discussed. Any of the previous structures, encompassing both solid-state structures and/or liquid-electrolyte structures, may variously include any of the following characteristics.

FIG. 6 shows a schematic cross-sectional view of battery cell materials 600 according to some embodiments of the present technology. Although illustrated as two battery cell segments, it is to be understood that any number of battery cell segments are encompassed, as well as any of the current collector configurations previously described. As illustrated, separator materials may be used to limit edge exposure of the electrode materials. Although any separator materials may be used, in some embodiments, separator materials may be deposited on the active layers as an electrode stack is being developed. In some embodiments, this deposition may extend over edge regions of the electrodes. For example, to limit exposure of cathode materials to an arcuate section of an anode current collector, separator materials may be extended over edges encompassed by the arcuate regions, as well as other lateral edges of the structure.

Because the arcuate sections of the current collectors may define outer lateral dimensions of the battery cells, this extension of separator materials laterally may not affect the lateral dimensions of the cell. As illustrated, either of separator 609a of a first cell segment and separator 609b of a second cell segment may extend about edges of the active materials. Either or both of these separator extensions may be performed, in embodiments. For example, separator 609b may be the only extension included, which may encompass the edges of cathode active material 607 from exposure to the anode current collector 620, such as the arcuate portion extending along the thickness of the electrode stack. Although not illustrated, similar coverage may be afforded on any layer, and for either current collector.

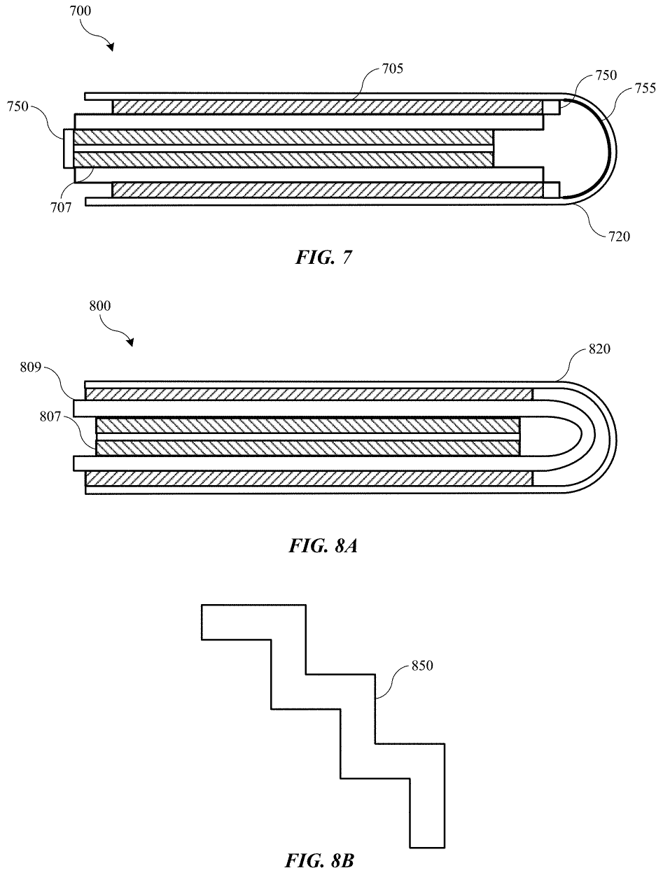

FIG. 7 shows a schematic cross-sectional view of battery cell materials 700 according to some embodiments of the present technology. Again, although only two cell segments are illustrated for an electrode stack, it is to be understood that any number of cell segments may be included according to any of the previously described configurations. In some embodiments as illustrated, edge regions 750 of the active materials may be passivated or made inert. For example during formation or stacking, anode materials and cathode materials may be laterally offset from one another in one or more directions. For example, anode active materials 705 may be laterally offset in a direction of overhang of the corresponding anode current collector 720, such as towards the arcuate section of the anode current collector. In layers where the anode current collector extends back in the opposite direction, the encompassed anode active material layers may be laterally offset in that direction instead. Similarly, cathode active material 707 may be laterally offset in an opposite direction, or in a different lateral direction, or not offset in embodiments. The edge regions 750 may then be passivated or rendered inert in one or more ways. For example the edges may be coated in a dielectric, ceramic, or otherwise insulating material. The edges may also be passivated by a treatment to render the materials inert. Additionally, the edges may be ablated to render the edges inert, which may limit the capability of shorting from any edge region.

In some embodiments exposed surfaces 755 of the current collectors may be passivated or made inert. For example, the arcuate sections of the anode current collector and/or cathode current collector may be coated with a material, or passivated—such as by being oxidized, for example, to render the exposed exterior of the surface of the current collector incapable of shorting to the electrode active materials.

FIG. 8A shows a schematic cross-sectional view of battery cell materials 800 according to some embodiments of the present technology where a separator material may be used to further protect exposure of the arcuate sections of the current collectors. For example, as illustrated, separator 809 may extend continuously between cell segments of the electrode stack, including all segments of the electrode stack. As illustrated, separator 809 may encompass cathode active materials 807 along an edge encompassed by an arcuate section of anode current collector 820. As shown, the separator may be disposed between the electrode sections and the current collector.

In some embodiments the separator may extend between all arcuate sections of the current collectors, which may include anode and/or cathode sections. For example, where a continuous anode current collector and a continuous cathode current collector extend along orthogonal lateral axes as described previously, a continuous separator may extend through every cell segment of the electrode stack. A continuous separator may also be incorporated when only a single continuous current collector is utilized. FIG. 8B shows a schematic plan view of an exemplary separator 850 according to some embodiments of the present technology. As illustrated, separator 850 may be characterized by pinked edges or in a zig-zag manner, which may facilitate folding in a first direction between a first cell segment and a second cell segment, followed by folding in a second direction orthogonal to the first between the second cell segment and a third cell segment, followed by folding in a third direction opposite the first direction between the third cell segment and a fourth cell segment. This may be continued through any number of cell segments, and maintain the continuous separator between all arcuate sections of both the anode current collector and cathode current collector. By using continuous woven current collectors according to embodiments of the present technology, improved interconnect structures may be afforded, while maintaining or improving energy density of a battery by reducing additional materials and layers within a stack.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A battery cell comprising:
an electrode stack including:
a first cell segment comprising an anode, a cathode, and a separator positioned between the anode and the cathode,
a second cell segment overlying the first cell segment and comprising an anode, a cathode, and a separator positioned between the cathode and the anode, and
a third cell segment overlying the second cell segment and comprising an anode, a cathode, and a separator positioned between the anode and the cathode, wherein layering of the anode and the cathode of the second cell segment is reversed from layering of the anode and the cathode of the first cell segment and the third cell segment;
a cathode current collector comprising a conductive material extending continuously in a U-shaped pattern to extend across and in contact with the cathode of each of the first cell segment, the second cell segment, and the third cell segment of the electrode stack; and
an anode current collector comprising a conductive material extending continuously in a U-shaped pattern to extend across and in contact with the anode of each of the first cell segment, the second cell segment, and the third cell segment of the electrode stack.

2. The battery cell of claim 1, wherein the cathode current collector extends through the electrode stack along a lateral axis orthogonal to a lateral axis along which the anode current collector extends through the electrode stack.

3. The battery cell of claim 1, wherein the cathode current collector extends through the electrode stack in a lateral axis similar to a lateral axis along which the anode current collector extends through the electrode stack, and wherein the cathode current collector and the anode current collector are offset vertically from one another between layers of the electrode stack.

4. The battery cell of claim 3, wherein the cathode current collector and the anode current collector are laterally offset from one another and extend less than or about halfway across a lateral surface of a corresponding electrode material.

5. The battery cell of claim 1, wherein the battery cell comprises a solid-state battery or a liquid electrolyte battery.

6. The battery cell of claim 5, wherein the separator encompasses edges of the anode and the cathode along electrode edges further encompassed by arcuate sections of the cathode current collector or the anode current collector.

7. The battery cell of claim 1, wherein the separator extends continuously between each of the first cell segment of the electrode stack, the second cell segment of the electrode stack, and the third cell segment of the electrode stack, and wherein the separator extends in alternating orthogonal directions between each of the first cell segment of the electrode stack, the second cell segment of the electrode stack, and the third cell segment of the electrode stack.

8. The battery cell of claim 7, wherein the alternating orthogonal directions correspond with an overhang portion of each of the cathode current collector and the anode current collector.

9. The battery cell of claim 1, wherein an exposed cathode edge and an exposed anode edge are passivated or inert.

10. The battery cell of claim 9, wherein the anode and the cathode of each of the first cell segment of the electrode stack, the second cell segment of the electrode stack, and the third cell segment of the electrode stack are laterally offset in a direction of overhang of a corresponding current collector.

11. The battery cell of claim 10, wherein a laterally offset portion of each of the anodes and each of the cathodes is ablated, passivated, or coated with an insulating material.

12. A battery cell comprising:
a first electrode stack comprising an anode, a separator, and a cathode;
a cathode current collector extending across the cathode of the first electrode stack on a surface of the cathode of the first electrode stack opposite a surface of the cathode of the first electrode stack in contact with the separator of the first electrode stack;
a second electrode stack comprising an anode, a separator, and a cathode, and characterized by a reversed layer orientation from the first electrode stack, wherein the cathode of the second electrode stack is in contact with a surface of the cathode current collector opposite the surface of the cathode current collector in contact with the cathode of the first electrode stack; and
an anode current collector extending across a surface of each of the anode of the first electrode stack and a surface of the anode of the second electrode stack, wherein the anode current collector is characterized by substantially planar ends extending substantially parallel to one another and in contact with a respective anode, the substantially planar ends connected by an arcuate portion of the anode current collector extending along a thickness of the first electrode stack and the second electrode stack.

13. The battery cell of claim 12, wherein the anode current collector is characterized by a first surface and a second surface opposite the first surface, wherein the first surface of the anode current collector is in contact with the anode of the first electrode stack, and wherein the first surface of the anode current collector is in contact with the anode of the second electrode stack.

14. The battery cell of claim 13, further comprising a third electrode stack comprising an anode, a separator, and a cathode, and characterized by a similar layer orientation as the first electrode stack, wherein the anode of the third electrode stack is in contact with the second surface of the anode current collector opposite the first surface of the anode current collector in contact with the anode of the second electrode stack.

15. The battery cell of claim 14, wherein the cathode current collector is further characterized by an arcuate portion extending along a thickness of the second electrode stack and the third electrode stack.

16. The battery cell of claim 13, wherein the arcuate portion of the anode current collector is passivated along at least one of the first surface of the anode current collector and the second surface of the anode current collector.

17. The battery cell of claim 12, wherein the battery cell comprises a solid-state battery or a liquid electrolyte battery.

18. The battery cell of claim 17, wherein the separator of the first electrode stack is the separator of the second electrode stack, and wherein the separator encompasses an edge of the cathode of the first electrode stack and an edge of the cathode of the second electrode stack along an edge of the first electrode stack and the second electrode stack encompassed by the arcuate portion of the anode current collector.

19. The battery cell of claim 12, wherein the anode and the cathode of each of the first electrode stack and the second electrode stack are laterally offset in a direction of overhang of a corresponding current collector.

20. The battery cell of claim 12, wherein a portion of the anode of the first electrode stack and a portion of the cathode of the first electrode stack is ablated, passivated, or coated with an insulating material.
